(19) United States
(12) Patent Application Publication
(10) Pub. No.: US 2020/0369249 A1
(43) Pub. Date: Nov. 26, 2020

(54) METHOD FOR CONTROLLING A HYDRAULIC BRAKE SYSTEM DURING A REGENERATIVE BRAKING PROCESS, HYDRAULIC BRAKE SYSTEM, COMPUTER PROGRAM PRODUCT, CONTROL UNIT AND MOTOR VEHICLE

(71) Applicant: ZF Active Safety GmbH, Koblenz (DE)

(72) Inventor: Andreas Marx, Hartenfels (DE)

(73) Assignee: ZF Active Safety GmbH, Koblenz (DE)

(21) Appl. No.: 16/881,648

(22) Filed: May 22, 2020

(30) Foreign Application Priority Data
May 23, 2019 (DE) 102019113754.3

(51) Int. Cl. B60T 8/17; B60L 7/26; B60T 13/58; B60T 13/68; B60T 13/16; B60T 8/176

(52) U.S. Cl. CPC B60T 8/17; B60L 7/26; B60T 13/586; B60T 13/686; B60T 2270/10; B60T 8/176; B60T 2270/604; B60T 2270/602; B60T 13/161

(57) ABSTRACT

The present disclosure relates to a method for controlling a hydraulic brake system during a regenerative braking process. In the method, a hydraulic fluid is displaced in the direction of a wheel brake by means of a brake cylinder. In the method, furthermore, at least a volume fraction of the hydraulic fluid is conducted via a pressure dissipation valve into an accumulator, an isolation valve is adjusted in the direction of a closed state in order to at least partially hydraulically isolate the wheel brake from the brake cylinder, and at least a volume fraction of the hydraulic fluid is conveyed out of the wheel brake by means of a pump. The present disclosure furthermore comprises a hydraulic brake system for a motor vehicle, a computer program product, a control unit and a motor vehicle.

### CROSS-REFERENCE TO RELATED APPLICATION

This application claims priority to German Patent Application No. 102019113754.3 filed May 23, 2019, the disclosure of which is incorporated herein by reference in its entirety.

### TECHNICAL FIELD

The present disclosure relates to a method for controlling a hydraulic brake system during a regenerative braking process. The present disclosure furthermore relates to a hydraulic brake system. The present disclosure furthermore relates to a computer program product, a control unit and a motor vehicle.

### BACKGROUND

Hydraulic brake systems are used for example in motor vehicles and serve primarily as a service brake for the motor vehicle. A braking operation is commonly performed by virtue of the driver of the motor vehicle actuating a brake pedal and a hydraulic fluid thus being displaced from a brake cylinder to at least one wheel brake, such that, at the wheel brake, a braking force prevails which acts on an associated vehicle wheel. This hydraulic braking force effected by means of the hydraulic fluid commonly corresponds to a braking force demand which is imparted by the driver through the actuation of the brake pedal.

Modern motor vehicles with a hydraulic brake system increasingly have a regenerative braking function in the following manner: In the presence of a braking force demand input through actuation of the brake pedal, an electric machine operating in the generator mode is at least temporarily driven by the kinetic energy of the motor vehicle and supplies electrical energy, which can be utilized for example for charging an electrical energy store of the motor vehicle. The electric machine used for this purpose is commonly the electric machine which forms an electric drive for the motor vehicle, for example as a main drive or secondary drive, and which is operated as a generator during the course of an occurring regenerative braking process.

The generator operation of the electric machine is however associated with a drag torque which originates from the electric machine and which exerts a braking action on the motor vehicle. This braking force caused by the electric machine, which will hereinafter also be referred to as generator braking force, must be taken into consideration in the dimensioning of the hydraulic braking force to be applied in order to meet a braking force demand input by the driver through actuation of the brake pedal. One possible concept in this regard is described in WO 2014/082885 A1.

The document discloses a method for controlling a hydraulic brake system during a regenerative braking process. In the method, at least a volume fraction of a hydraulic fluid which is displaced from a brake cylinder in the direction of a wheel brake is temporarily stored in a hydraulic accumulator via a pressure dissipation valve. It is made possible in this way that, in the case of a predefined braking force demand and an associated displacement of the hydraulic fluid, a hydraulic braking force action on the wheel brake is omitted at least to the extent that the electric machine can be incorporated for the purposes of generating electrical energy and, despite the generator braking force originating from the electric machine, the resulting overall braking force corresponds to the input braking force demand.

### SUMMARY

It is an object of the present disclosure to propose at least one possibility for improving the previous concept of a regenerative braking operation.

The object is achieved by means of a method which has the features of claim 1. The object is furthermore achieved by means of a hydraulic brake system which has the features of claim 5. Furthermore, to achieve the object, a computer program product having the features of claim 8, a control unit having the features of claim 9 and a motor vehicle having the features of claim 10 are proposed. Advantageous embodiments and/or refinements and/or aspects of the present disclosure will emerge from the subclaims, from the following description and from the figures.

An underlying method for controlling a hydraulic brake system, for example of a motor vehicle, during a regenerative braking process comprises the step whereby a hydraulic fluid, in particular a brake fluid, is displaced in the direction of a wheel brake by means of a brake cylinder. In particular, the displacement of the hydraulic fluid implies a braking force demand, in particular a present braking force demand. For example, the wheel brake is assigned to a vehicle wheel or is configured to be assigned to a vehicle wheel. For example, the displacement of the hydraulic fluid is caused directly or indirectly by means of an actuation of the brake pedal or of some other actuating device. For example, the displacement of the hydraulic fluid corresponds to a braking force demand, in particular present braking force demand, input by means of the brake pedal or the actuating device. For example, the actuation is performed by the driver of the motor vehicle.

The method furthermore comprises the step whereby at least a volume fraction of the hydraulic fluid is conducted via a pressure dissipation valve, which is preferably situated in an open position, into an accumulator, in particular intermediate accumulator. In this way, a measure is implemented whereby a hydraulic braking force action on the wheel brake corresponding to the displacement of the hydraulic fluid is omitted. In this way, it is made possible by means of the method for the hydraulic brake system to be able to be utilized for a regenerative braking process in which an electric machine is or has been incorporated for the purposes of generating electrical energy. The drag torque originating from the electric machine for system reasons duly acts as a braking force on the motor vehicle, but the generator braking torque, hereinafter also referred to for simplicity as generator braking force, can, owing to the at least one volume fraction of the hydraulic fluid being conducted onward into the accumulator, and owing to the hydraulic braking force thus being at least partially or entirely omitted, now be utilized for covering the input braking force demand. For example, the accumulator may be dimensioned in terms of its volume capacity such that the displaced hydraulic fluid imparts no or substantially no hydraulic braking force on the wheel brake. In this case, with displacement of the hydraulic fluid, in the first instance only the generator braking force originating from the electric machine is effective.

In one embodiment, the method comprises the steps whereby an isolation valve is adjusted in the direction of a closed state in order to at least partially hydraulically isolate the wheel brake from the brake cylinder, and in particular at least a volume fraction of the hydraulic fluid is conveyed out of the wheel brake by means of a pump, for example in order to reduce acting residual braking forces. In this way, it is for example the case that undesired friction forces, which act as a braking force in the wheel brake, are counteracted. Such friction forces may be caused by resetting forces. For example, such friction forces are caused by the fact that the at least one volume fraction of the hydraulic fluid is stored under pressure in the accumulator. A reduction of such undesired forces promotes an increase in the recuperative yield by means of the electric machine, because, to the extent that these forces are reduced, the generator braking force can instead act in order to satisfy the input braking force demand, and thus generator operation of the electric machine can already be implemented.

In particular, provision is made whereby the hydraulic fluid is displaced from the brake cylinder in the direction of the wheel brake, and the at least one volume fraction of the hydraulic fluid is simultaneously or subsequently conducted via the pressure dissipation valve into the accumulator. In particular, provision is furthermore made whereby the isolation valve is adjusted in the direction of the closed state simultaneously with, or in a manner offset in terms of time in relation to, the conducting of the at least one volume fraction onward into the accumulator. In particular, provision is furthermore made whereby the at least one volume fraction of the hydraulic fluid is conveyed out of the wheel brake by means of the pump simultaneously with or subsequently to the adjustment of the isolation valve.

In a further embodiment, provision is made whereby the isolation valve is adjusted into the closed state, in particular in order to hydraulically fully isolate the wheel brake from the brake cylinder. In particular, provision is furthermore made whereby such a volume fraction of the hydraulic fluid is conveyed out of the wheel brake that no braking force acts on the wheel brake. These measures have the aim of placing the wheel brake into a hydraulically unpressurized state.

An underlying hydraulic brake system, for example for a motor vehicle, in particular for carrying out the method described above, comprises a brake cylinder and a wheel brake which are hydraulically connected to one another via a feed line, wherein the brake cylinder is configured to displace a hydraulic fluid in the direction of the wheel brake, and the wheel brake is configured to impart a hydraulic braking force by means of the hydraulic fluid. The hydraulic brake system furthermore comprises an isolation valve, which is fluidically assigned to the feed line and which is configured to close the feed line. Furthermore, the hydraulic brake system comprises a return line for returning at least a volume fraction of the hydraulic fluid from a region positioned downstream of the isolation valve into a region positioned upstream of the isolation valve.

The “region positioned downstream” is to be understood in particular to mean that receiving volume of the brake system for receiving hydraulic fluid which is positioned downstream of the isolating valve as viewed in the flow direction with respect to the feed line, that is to say in the direction from the brake cylinder to the wheel brake. For example, the region positioned downstream comprises a hydraulic receiving volume of the feed line which is positioned downstream of the isolating valve, and/or comprises a hydraulic receiving volume of the wheel brake.

The “region positioned upstream” is to be understood in particular to mean that receiving volume of the brake system for receiving hydraulic fluid which is positioned upstream of the isolating valve as viewed in the flow direction with respect to the feed line, that is to say in the direction from the brake cylinder to the wheel brake. For example, the region positioned upstream comprises a hydraulic receiving volume of the feed line which is positioned upstream of the isolating valve and/or comprises a hydraulic receiving volume of the brake cylinder and/or of a provided reservoir/replenishment vessel for the hydraulic fluid.

The hydraulic brake system furthermore comprises a pressure dissipation valve, a pump and an accumulator, which are fluidically assigned to the return line. The pump is configured to convey at least a volume fraction of the hydraulic fluid. The accumulator is configured to store at least a volume fraction of the hydraulic fluid, in particular to store the same under a counterpressure. Furthermore, the pressure dissipation valve is configured to open the return line. For example, as viewed in the direction of a return from the region positioned downstream into the region positioned upstream, the pressure dissipation valve, the pump and the accumulator are arranged in the sequence: pressure dissipation valve, accumulator, pump.

Also provided in the hydraulic brake system is a control unit which is connected in signal-exchanging fashion to the isolation valve, the pressure dissipation valve and the pump. In particular, the control unit is configured to activate and/or communicate with the isolation valve and/or the pressure dissipation valve and/or the pump. For example, the control unit is furthermore connected in signal-exchanging fashion to an electric machine which is utilized during regenerative braking. In particular, the control unit is configured to control the electric machine and/or communicate with the electric machine. For example, the control unit is furthermore connected in signal-exchanging fashion to an actuating device for actuating the brake cylinder, such as for example a brake pedal or a brake lever, and/or to at least one sensor element assigned to the actuating device, such as for example a travel sensor, in particular a pedal travel sensor, and/or a force sensor, in particular a pedal force sensor.

In particular, the control unit is configured to communicate with the actuating device and/or with the at least one sensor element and/or to receive signals from the actuating device and/or from the at least one sensor element, and to take the signals into consideration with regard to an activation of the isolation valve and/or of the pressure dissipation valve and/or of the pump and/or of the electric machine. The control unit may be in hardware form and/or software form, for example in the form of a computer program or computer program module, or may be a constituent part of an item of hardware and/or an item of software.

In one embodiment, the control unit is configured such that, in the presence or upon an onset of an actuation of the brake cylinder and in particular in the presence or upon an onset of a generator braking force of an electric machine, such as for example of the electric machine described above, the control unit activates the pressure dissipation valve for opening and activates the isolation valve for closing, in order to at least partially hydraulically isolate the wheel brake from the brake cylinder, and furthermore activates the pump to impart a conveying action, in particular in order to lower a residual braking force which has a braking action on the wheel brake. As a result, with respect to the refinement of the control unit, a possibility is proposed for carrying out the above-described method and thus achieving the advantages described with regard to the method.

The “onset of an actuation of the brake cylinder” is to be understood in particular to mean that an actuation of the brake cylinder has not yet taken place or is not yet taking place, that is to say in particular the hydraulic fluid has not yet been or is not yet being displaced in the direction of the wheel brake, but a preparatory operation has already been performed or is already being performed and/or a braking-relevant state has taken effect, from which a required actuation of the brake cylinder can be derived or is to be derived. In particular, upon the onset of an actuation of the brake cylinder, the wheel brake does not yet exert a braking force, that is to say no hydraulic braking force has yet been built up by the wheel brake.

The preparatory operation may be or comprise a light initial depression or light initial touch of an actuating device that is coupled in terms of actuation to the brake cylinder, for example of a brake pedal or of a brake lever. Also, the preparatory operation may comprise or consist in an actuated accelerator/gas pedal being varied in the direction of less gas or an actuation of an accelerator/gas pedal being ended, for example because a subsequent actuation of the actuating device is to be expected. The preparatory operation may be performed by the driver of the motor vehicle or by an adjusting element of a vehicle controller, for example of an automated driving system or autopilot or of a driver assistance system or the like.

The braking-relevant state may be caused by an obstruction in the path of travel of the motor vehicle and/or a departure of the track of the motor vehicle from a predefined traffic lane and/or some other visually and/or acoustically perceptible action on the motor vehicle and/or on the driving behavior thereof or the driving characteristics thereof. The braking-relevant state may be detected by means of at least one sensor element of a vehicle controller, for example of an automated driving system or autopilot or of a driver assistance system or the like. For example, the presence of such a braking-relevant state is identified by the vehicle controller on the basis of the information items from the at least one sensor element.

The “onset of a generator braking force of the electric machine” is in particular also to be understood to mean that the electric machine is to be switched into the generator mode, for example by virtue of an electrical energization of the electric machine being withdrawn or switched off. In particular, the electrical energization of the electric machine is withdrawn or switched off in a manner dependent on an actuation of the actuating device which is coupled in terms of actuation to the brake cylinder. For example, the electrical energization of the electric machine is withdrawn or switched off in a manner dependent on an actuation of the accelerator/gas pedal and/or of the brake pedal of the motor vehicle. The actuation of the actuating device or of the accelerator/gas pedal and/or of the brake pedal may be performed by the driver of the motor vehicle or by a vehicle controller, for example an automated driving system or autopilot or a driver assistance system or the like.

The expression “vehicle controller” is to be understood in particular to mean a control system which effects an actuation of the brake cylinder independently of an actuation of the brake pedal performed by the driver. Such a control system, which may also be referred to as automatic vehicle controller, may be a driver assistance system. The driver assistance system is for example a distance-regulating cruise control system (ACC; Adaptive Cruise Control), which performs radar-based closed-loop control of the distance to a vehicle traveling ahead by means of braking and engine interventions, or a driving dynamics regulation system (ESC; Electronic Stability Control), which seeks, through targeted braking of individual wheels of the motor vehicle, to prevent skidding of the motor vehicle in a limit range during cornering both in the case of oversteering and in the case of understeering of the motor vehicle, and thus to ensure that the driver has control over the motor vehicle.

By virtue of the control unit being configured such that, in the presence or upon an onset of an actuation of the brake cylinder and in particular in the presence or upon an onset of a generator braking force of the electric machine, the control unit activates the pressure dissipation valve for opening, it is made possible that a hydraulic braking force action on the wheel brake to an extent conforming to a displacement of the hydraulic fluid originating from the brake cylinder is omitted when the actuation of the brake cylinder occurs. This is because at least a volume fraction of the hydraulic fluid is, as a result of the opening of the pressure dissipation valve, conducted via the return line into the accumulator and received therein. By means of this omission of the hydraulic braking force action to an extent conforming to the displacement of the hydraulic fluid, it is in turn made possible for the electric machine to be incorporated for the purposes of generating electrical energy, without an undesired additional braking force action occurring. The drag torque originating from the electric machine for system reasons then duly acts as a braking force on the motor vehicle, but the generator braking force can, owing to the at least one volume fraction of the hydraulic fluid being conducted onward into the accumulator, and owing to the hydraulic braking force thus being at least partially or entirely omitted, now be utilized for covering the braking force demand that has been input through the actuation of the brake cylinder.

By virtue of the control unit being configured such that, in the presence or upon an onset of an actuation of the brake cylinder and in particular in the presence or upon an onset of a generator braking force of the electric machine, the control unit activates the isolation valve for closing and activates the pump to impart a conveying action, it is made possible to counteract undesired braking forces in the wheel brake. This is because, as a result of the closing of the isolation valve, the wheel brake is at least partially or fully isolated from the brake cylinder, and, by means of the conveying action of the pump, at least a volume fraction of the hydraulic fluid is conveyed out of the wheel brake, such that a reduction of the hydraulic pressure in the wheel brake occurs. The undesired braking forces are for example friction forces in the wheel brake, which are caused by resetting forces from the accumulator, because the at least one volume fraction of the hydraulic fluid is stored under pressure in the accumulator. A reduction of such undesired forces promotes an increase in the recuperative yield by means of the electric machine, because, to the extent that these forces are reduced, the generator braking force can instead act in order to satisfy the input braking force demand, and thus generator operation of the electric machine can already be implemented.

One possible embodiment consists in that the control unit is configured such that in the presence or upon an onset of an actuation of the brake cylinder and in particular in the presence or upon an onset of a generator braking force of the electric machine, the control unit activates the pressure dissipation valve for opening, subsequently or simultaneously activates the isolation valve for closing, and, subsequently to or simultaneously with the activation of the isolation valve, activates the pump to impart a conveying action. A different sequence is basically also possible. For example, the control unit may be configured such that, in the presence or upon an onset of an actuation of the brake cylinder and in particular in the presence or upon an onset of a generator braking force of the electric machine, the control unit activates the isolation valve for closing, subsequently activates the pressure dissipation valve for opening and, subsequently to or simultaneously with the activation of the pressure dissipation valve, activates the pump to impart a conveying action. For example, the control unit may furthermore be configured such that, in the presence or upon an onset of an actuation of the brake cylinder and in particular in the presence or upon an onset of a generator braking force of the electric machine, the control unit activates the isolation valve for closing, subsequently or simultaneously activates the pump to impart a conveying action, and, subsequently to or simultaneously with the activation of the pump, activates the pressure dissipation valve for opening.

Provision may be made whereby the isolation valve and/or the pressure dissipation valve and/or the pump and/or the accumulator and/or the control unit are for example a constituent part of an anti-lock braking system (ABS) or of a driving dynamics control system (ESC) of the motor vehicle or for the motor vehicle. This promotes cost advantages, because the components involved then perform a multiple function or a multiple use.

In the present description, the expression “wheel brake” is to be understood in particular to mean a friction brake, such as for example a disk brake or a drum brake. In particular, the wheel brake is configured to be utilized as a service brake. For example, the wheel brake is assigned to a vehicle wheel or is configured to be assigned to a vehicle wheel.

In the present description, the expression “brake cylinder” is to be understood in particular to mean a device which generates fluid pressure. The brake cylinder may comprise a pressure piston which is for example held displaceably in a cylinder and which, by means of a displacement movement of the pressure piston relative to the cylinder, effects a displacement of a hydraulic fluid or of a hydraulic fluid volume. The expression “brake cylinder” in particular also encompasses a conveying pump or similar conveying device as a device which generates fluid pressure. The brake cylinder may be a master brake cylinder. For example, the brake cylinder is a master brake cylinder such as is common in conventional hydraulic brake systems. For example, the brake cylinder comprises a reservoir and/or a replenishment vessel for the hydraulic fluid.

In particular, the brake cylinder interacts with an actuating device, or the brake cylinder is configured to interact with an actuating device. The actuating device may be the actuating device already described above. In particular, an actuation of the actuating device has the effect, at the brake cylinder, that a displacement of the hydraulic fluid occurs. For example, an actuation of the brake cylinder is realized mechanically, in particular purely mechanically, or electrically or electromechanically.

For example, the actuating device comprises a brake pedal or a brake lever which acts, for example via a piston rod, on the brake cylinder so as to generate fluid pressure. In addition or alternatively, the actuating device may comprise an electric machine, in particular an electric motor, wherein an output shaft of the electric machine is coupled in terms of drive to the brake cylinder in order to thereby actuate the brake cylinder. The actuating device may be actuated manually for example by the driver of the motor vehicle or automatically or in self-acting fashion by means of a vehicle controller, for example the vehicle controller described above.

In the present description, the expression “isolation valve” is to be understood in particular to mean a shut-off element by means of which the wheel brake can be at least partially hydraulically decoupled, that is to say isolated, from the brake cylinder. In particular, the isolation valve is configured to close and open the feed line. In particular, the isolation valve is configured to completely close or at least partially close the feed line. For example, the isolation valve has a passage for fluid, in particular the hydraulic fluid, which passage is of variable cross section. For example, the isolation valve is configured to be adjusted between a closed position and an open position, for example with regard to the passage, wherein, in the closed position, the feed line is at least partially or completely closed, that is to say shut off.

For example, the isolation valve is configured to be electrically and/or electromagnetically actuated, in particular in order to be adjusted or switched, for example adjusted and/or switched in continuously variable or stepped and/or digital or analog fashion, between the closed position and the open position. For example, the isolation valve is or comprises a 2/2 directional valve, which, for example, assumes the open position in a non-actuated state and the closed position in an actuated state. If it is an electrically or electromagnetically actuated isolation valve, it is for example electrically deenergized in the non-actuated state and electrically energized in the actuated state. For example, the isolation valve is a valve with an NO function. The NO function is to be understood in particular to mean that the valve is open in the electrically deenergized state. Such a valve may also be referred to as a “normally open” NO valve. For example, the isolation valve is a preferably directly controlled solenoid valve with an NO function.

In the present description, the expression “pressure dissipation valve” is to be understood in particular to mean a shut-off element by means of which the return line can be at least partially or fully opened, for example proceeding from a shut-off state. For example, the pressure dissipation valve has a passage for fluid, in particular the hydraulic fluid, which passage is of variable cross section. For example, the pressure dissipation valve is configured to be adjusted between a closed position and an open position, for example with regard to the passage, wherein, in the open position, the return line is at least partially or completely opened.

For example, the pressure dissipation valve is configured to be electrically or electromagnetically actuated, in order to be adjusted or switched, for example adjusted and/or switched in continuously variable or stepped and/or digital or analog fashion, between the closed position and the open position. For example, the pressure dissipation valve is or comprises a 2/2 directional valve, which, for example, assumes the closed position in a non-actuated state and the open position in an actuated state. If it is an electrically or electromagnetically actuated pressure dissipation valve, it is for example electrically deenergized in the non-actuated state and electrically energized in the actuated state. For example, the pressure dissipation valve is a valve with an NC function. The NC function is to be understood in particular to mean that the valve is closed in the electrically deenergized state. Such a valve may also be referred to as a “normally closed” NC valve. For example, the pressure dissipation valve is a preferably directly controlled solenoid valve with an NC function.

In the present description, the expression “pump” is to be understood in particular to mean a conveying device for conveying hydraulic fluid. For example, the pump is a rotary pump, in particular a radial piston pump or an axial piston pump. In particular, the rotary pump comprises at least one, preferably multiple, for example two to six, working piston(s), which perform(s) or can perform a reciprocating movement for the purposes of conveying the hydraulic fluid. For example, the pump comprises an electric machine, for example an electric motor, which serves for driving the pump. The electric machine is for example configured to receive electrical control signals and output corresponding control signals to the pump.

The expression “accumulator” is to be understood in particular to mean a hydro accumulator or hydraulic accumulator which is for example configured to store the hydraulic fluid under pressure. That volume fraction of the hydraulic fluid which is conducted to the accumulator is thus received therein counter to a resetting force of the accumulator. The accumulator may be designed such that a gas or a spring element is compressed during a process of filling with the hydraulic fluid. For example, the accumulator is a buffer accumulator which is configured to temporarily buffer-store the at least one volume fraction of the hydraulic fluid.

In the present description, the expression “control unit” is to be understood in particular to mean an electronic unit of an item of computer hardware which, in conjunction with the hydraulic brake system and for example an electric machine utilized during regenerative braking, controls particular processes and/or sequences. The control unit may have a digital processing unit, which comprises for example a microprocessor unit (CPU). The CPU may be connected in data-exchanging and/or signal-exchanging fashion to a memory system and/or bus system. The control unit may have one or more programs or program modules. The digital processing unit may be designed such that commands that are implemented as a program stored in a memory system are executed, input signals are received from a data bus system, and/or output signals are output to a data bus system. A memory system may have one or more, in particular different, memory media. The memory media may in particular be optical, magnetic, solid-state memory media and/or other, preferably nonvolatile memory media.

According to one aspect, the present disclosure furthermore relates to a computer program product having program code, which is stored on a computer-readable medium, for carrying out an embodiment of the above-described method.

According to a further aspect, the present disclosure relates to a control unit, in particular for the above-described hydraulic brake system, comprising the above-described computer program product.

According to a further aspect of the present disclosure, a motor vehicle having the above-described hydraulic brake system and/or having the above-described computer program product and/or having the above-described control unit is provided.

According to one embodiment, the motor vehicle comprises at least one vehicle wheel and at least one electric machine connected in terms of drive to the vehicle, which electric machine is configured to be utilized as a generator during a braking process of the motor vehicle. The electric machine may be the electric machine described above.

In particular, the electric machine is configured to be present only in a generator mode or to be switched, in particular manually or automatically switched, into a generator mode upon an onset of a braking process of the motor vehicle, in particular upon an onset of a displacement of the hydraulic fluid by means of the brake cylinder. For example, the electric machine is an electric drive of the motor vehicle, which, for example as a main drive or secondary drive, acts with driving action on the at least one vehicle wheel and, during a braking process of the motor vehicle, is utilized as a generator in order, for example, to charge an electrical energy store of the motor vehicle.

### BRIEF DESCRIPTION OF THE DRAWINGS

Further details and features of the present disclosure will emerge from the following description of two exemplary embodiments on the basis of the drawing. In the drawing:

FIG. 1 shows a possible embodiment of a hydraulic brake system, which is suitable for carrying out a regenerative braking process, in a schematic illustration, and

FIG. 2 shows a further possible embodiment of a hydraulic brake system, which is suitable for carrying out a regenerative braking process, in a schematic illustration.

### DETAILED DESCRIPTION

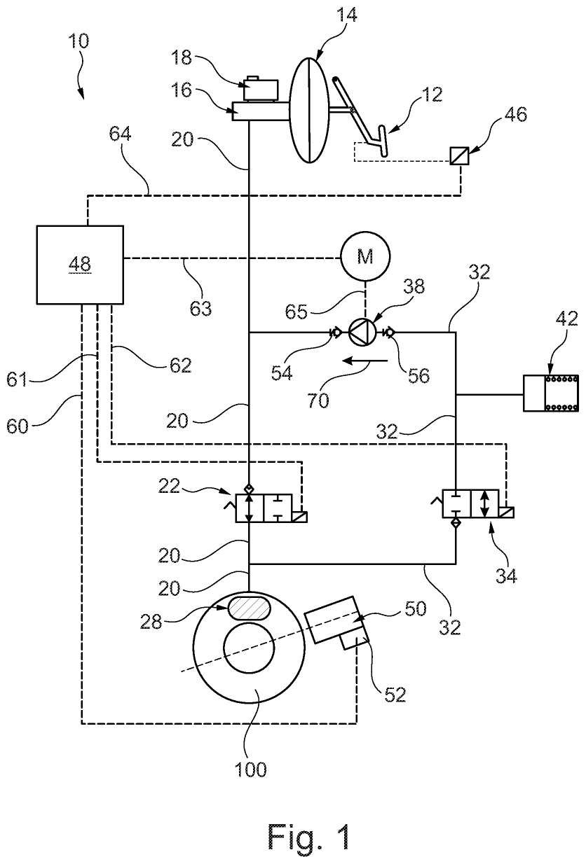

FIG. 1 shows a possible embodiment of a hydraulic brake system 10 which is used for example in a motor vehicle. In FIG. 1, the hydraulic brake system 10 is illustrated by way of example in conjunction with one vehicle wheel 100. The hydraulic brake system 10 is configured to be able to perform a regenerative braking process. In the regenerative braking process, the kinetic energy of the motor vehicle is utilized in order to drive an electric machine 50 in generator mode and thereby generate electrical energy. The electrical energy can be utilized for example to charge an electrical energy store of the motor vehicle. By way of example, in FIG. 1, the electric machine 50 is assigned to the vehicle wheel 100 in order to illustrate that the electric machine 50 is driven by the movement of the vehicle, that is to say by the rotation of the vehicle wheel 100. The electric machine 50 is preferably a constituent part of an electric drive of the motor vehicle, which serves for example for driving the vehicle wheel 100. During a regenerative braking process, the electric drive is utilized as a generator.

The hydraulic brake system 10 comprises, for example, a brake cylinder 16 and a wheel brake 28, which are hydraulically connected to one another via a feed line 20. The brake cylinder 16 is configured to displace a hydraulic fluid in the direction of the wheel brake 28. The wheel brake 28 is configured to exert a braking force, for example in the form of a friction force, on the vehicle wheel 100 by means of the hydraulic fluid. The hydraulic brake system 10 is preferably assigned a brake pedal 12, by means of which the brake cylinder 16 is to be actuated. The brake cylinder 16 is preferably assigned a reservoir 18 for the purposes of storing hydraulic fluid for the hydraulic brake system 10 in the reservoir. The reservoir 18 may have an inlet opening in order to be refilled or filled via the inlet opening.

To boost an actuating force input by means of the brake pedal 12, for example by a driver of the motor vehicle, a brake force booster 14 may be provided. The brake force booster 14 preferably boosts the actuating force in a known manner in accordance with a pneumatic, electrohydraulic or electromechanical principle. In order, for automatic vehicle control, to actuate the brake cylinder independently of an actuation of the brake pedal by the driver, it is also possible for an electrically controlled brake force booster (EBB; Electronic Brake Booster) to be provided.

The hydraulic brake system 10 preferably furthermore comprises an isolation valve 22 which is fluidically assigned to the feed line 20 and which is configured to close the feed line. For example, it is the intention in this way for the wheel brake 28 to be able to be at least partially or entirely hydraulically isolated from the brake cylinder 16. The isolation valve 22 is preferably provided for adjustment between a closed position and an open position in order to close or shut off, in particular entirely or at least partially close or shut off, the feed line 20. Preferably, in the closed position of the isolation valve 22, the feed line 20 is shut off, in particular fully shut off or at least largely or substantially shut off, and, in the open position, the feed line 20 is open, in particular substantially open or fully open.

Preferably, the hydraulic brake system 10 furthermore comprises a return line 32 which serves for returning at least a volume fraction of the hydraulic fluid from a region positioned downstream of the isolation 22 valve into a region positioned upstream of the isolation valve 22. For example, the return line 32 is connected in terms of flow by means of one end to the feed line 20 in a region between the isolation valve 22 and the wheel brake 28. Preferably, the return line 32 is connected in terms of flow by means of another end to the feed line 20 in a region between the isolation valve 22 and the brake cylinder 16. In this way, at least a volume fraction of the hydraulic fluid can be returned from the wheel brake 28 into the feed line 20, bypassing the isolation valve 22.

Preferably, the return line 32 is fluidically assigned a pressure dissipation valve 34, a pump 38 and an accumulator 42. The pump 38 is configured to convey at least a volume fraction of the hydraulic oil, in particular in a return direction 70. Preferably, by means of a conveying action of the pump 38 in the return direction 70, the at least one volume fraction of the hydraulic fluid is conveyed in the direction of the region positioned upstream. The accumulator 42 is configured to store at least a volume fraction of the hydraulic fluid, in particular to store the same under pressure, in particular to buffer-store the same.

The pressure dissipation valve 34 is configured to open and close the return line 32. The pressure dissipation valve 34 is preferably provided for adjustment between a closed position and an open position in order to open, in particular entirely or at least partially open, the return line 32. Preferably, in the open position of the pressure dissipation valve 34, the return line 32 is open, in particular at least partially open or fully open, and, in the closed position, the return line 32 is closed or shut off, in particular entirely shut off or at least largely or substantially shut off. Preferably, as viewed in the return direction 70 of the hydraulic fluid, the pressure dissipation valve 34, the pump 38 and the accumulator 42 are arranged in the sequence in which the pressure dissipation valve 34 comes first, and is followed either by the pump 38 or the accumulator 42. By opening the return line 32, the accumulator 42 is thus filled with the returned volume fraction of the hydraulic fluid.

Preferably, the hydraulic brake system 10 furthermore comprises a control unit 48, in particular an electrical control unit, for activating the isolation valve 22 and/or the pressure dissipation valve 34 and/or the pump 38. For example, for this purpose, the control unit 48 is connected in signal-exchanging fashion to the isolation valve 22 and/or to the pressure dissipation valve 34 and/or to the pump 38 via a corresponding signal line 61 or 62 or 63 respectively, in particular electrical signal line. Preferably, the isolation valve 22 and/or the pressure dissipation valve 34 and/or the pump 38 has in each case one electrical receiver unit in order to process the control signals transmitted by the control unit 48 and initiate or perform a corresponding actuation of the isolation valve 22 or of the pressure dissipation valve 34 or of the pump 38 respectively.

For example, for this purpose, the pump 38 may have a corresponding actuating device, such as for example an electric drive motor M, which is activated by the control line 63 and which acts on the pump 38, in particular on a working cylinder of the pump 38, via a mechanical and/or hydraulic and/or electromagnetic actuation connection 65. Preferably, both control signals and state signals, for example signals with information items regarding monitored or detected parameters, are to be transmitted via the signal lines 61, 62, 63.

The control unit 48 is preferably connected in signal-exchanging fashion to the electric machine 50 for example via a signal line 60, in order to transmit control signals from the control unit 48 to the electric machine 50 and/or conversely in order to transmit control signals or signals containing information items regarding an operating state of the electric machine 50, for example, to the control unit 48. For this purpose, the electric machine 50 may have a control unit 52 which communicates via the signal line 60 with the control unit 48t and which activates, in particular directly activates, the electric machine 50.

Preferably, the control unit 48 is furthermore connected in signal-exchanging fashion via a signal line 64 to a sensor element assigned to the brake pedal 12, in particular a pedal travel sensor 46. The pedal travel sensor 46 serves for detecting a pedal travel of the brake pedal 12. Via the signal connection between the pedal travel sensor 46 and the control unit 48, the control unit 48 can take into consideration information items relating to the pedal travel.

The control unit 48 is preferably configured such that, in the presence or upon an onset of an actuation of the brake cylinder 16 and in particular in the presence or upon an onset of a generator braking force originating from the electric machine 50, the control unit activates the pressure dissipation valve 34 for opening and activates the isolation valve 22 for closing and furthermore activates the pump 38 to impart a conveying action. The control unit 48 is preferably configured such that, in the presence or upon an onset of an actuation of the brake cylinder 16 and in particular in the presence or upon an onset of the generator braking force, the pressure dissipation valve 34 is activated for opening, the isolation valve 22 is subsequently or simultaneously activated for closing, and, subsequently to or simultaneously with the activation of the isolation valve 22, the pump 38 is activated to impart a conveying action.

In order to identify or detect a presence or an onset of an actuation of the brake cylinder 16, the control unit 48 utilizes, for example, information items from the pedal travel sensor 46. In order to identify or detect a presence of a generator braking force of the electric machine 50, the control unit 48 utilizes, for example, signals from sensor elements which provide information items relating for example to the operating state of the electric machine 50. In addition or alternatively, it is also possible for the electric machine 50 to be utilized directly, for example by virtue of the control unit 48 using information items from the control unit 52 of the electric machine 50 for this purpose. If the control unit 48 identifies or detects that the electric machine 50 is not operating in the generator mode, for example because the electric machine 50 is still electrically energized, the control unit 48 may be configured to output a control command to the electric machine 50 to switch into the generator mode.

In order to perform a regenerative braking process without or substantially without hydraulic braking force action, the hydraulic brake system 10 may provide the following mode of functioning: An actuation of the brake pedal 12 or an onset of an actuation of the brake pedal 12 is identified or detected by the control unit 48. The pressure dissipation valve 34 is hereupon activated by the control unit 48 for opening. This results in an adjustment of the pressure dissipation valve 34 from its closed position (FIG. 1) to its open position and thus in an opening of the return line 32. As a result of the actuation of the brake pedal 12, a displacement of a hydraulic fluid from the brake cylinder 16 in the direction of the wheel brake 28 is effected via the feed line 20. Owing to the opened return line 32, at least a volume fraction of the hydraulic fluid is conducted into the accumulator 42 situated there, such that a hydraulic braking force corresponding to the displacement of the hydraulic fluid is not generated at the wheel brake 28.

By means of the actuation of the brake pedal 12, a braking force demand is input, which must be matched by generation of a braking force. For this purpose, the drag torque originating from the electric machine 50 is utilized, which acts as a braking force on the moving system, in particular the vehicle wheel 100. If, for example, the braking force demand is covered by this generator braking force originating from the electric machine 50, the opening of the pressure dissipation valve 34 is performed to such an extent that no or substantially no hydraulic braking force acts at the wheel brake 28. If, for example, the braking force demand is higher than the generator braking force, the opening of the pressure dissipation valve 34 is performed such that, at the wheel brake 28, such a level of hydraulic braking force is built up, owing to the displacement of the hydraulic fluid, that the hydraulic braking force and the generator braking force give rise to an overall braking force which corresponds or at least approximately corresponds to the braking force demand.

After the activation of the pressure dissipation valve 34 or after the opening of the pressure dissipation valve 34, the isolation valve 22 is activated for closing by the control unit 48. This results in an adjustment of the isolation valve 22 from its open position (FIG. 1) in the direction of its closed position and thus in a shutting-off of the feed line 20. In this way, the wheel brake 28 is hydraulically isolated from the brake cylinder 16. Furthermore, the pump 38 is activated, for imparting a conveying action, by the control unit 48, As a result of the conveying action by the pump 38, a volume fraction of the hydraulic fluid that is still situated in the wheel brake 28 is conveyed out to such an extent that no braking force or substantially no braking force acts at the wheel brake 28, in order that, in this way, the wheel brake 28 is placed in a hydraulically unpressurized state. When the actuation of the brake pedal 12 has been ended, the pressure dissipation valve 34 is activated for closing, and the isolation valve is activated for opening. The pump 38 still imparts a conveying action until such time as the accumulator 42 has been evacuated.

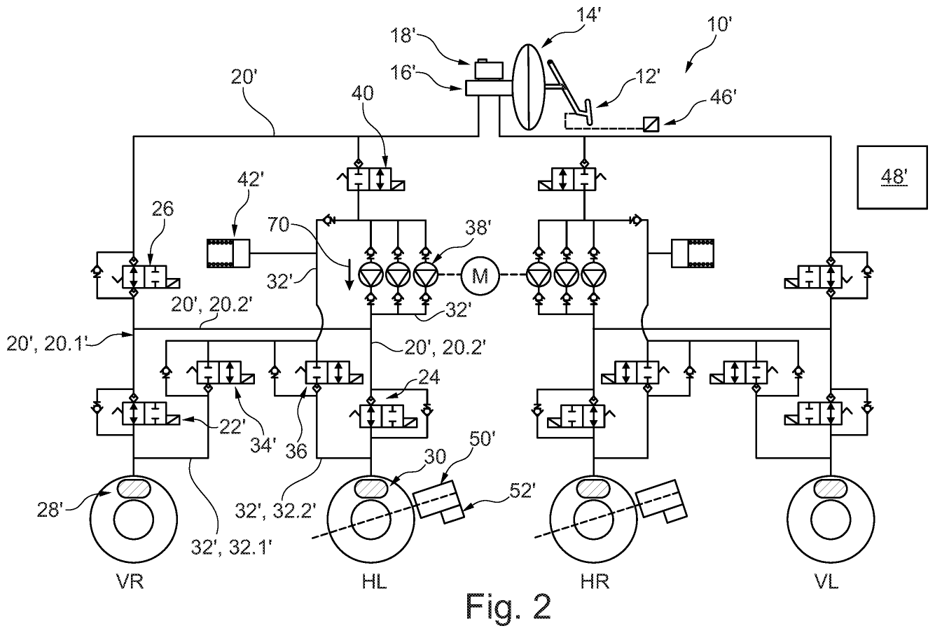

FIG. 2 shows a further possible embodiment of a hydraulic brake system 10′ which is suitable for performing a regenerative braking process and which may be used for example in a motor vehicle. In the hydraulic brake system 10′, two hydraulically mutually separate brake circuits are provided. There are preferably interactions between the two brake circuits. For example, a pressure equalization takes place via a common brake cylinder 16′, such that the same brake pressure prevails in both brake circuits. Below, only one of the brake circuits will be referred to, wherein the other brake circuit may be of identical and/or functionally identical construction. For the sake of simplicity and for better clarity, any signal lines that are present have been omitted in FIG. 2.

The hydraulic brake system 10′ of FIG. 2 is a brake system as described in WO 2014/082885 A1. In this respect, with regard to the construction and the functionality of the hydraulic brake system 10′, reference is made to the disclosure of WO 2014/082885 A1, which is hereby incorporated in its entirety into the description.

The above-described components of the hydraulic brake system 10 of FIG. 1 may likewise be present in the hydraulic brake system 10′. The hydraulic brake system 10′ comprises for example a brake pedal 12′, a brake force booster 14′, a brake cylinder 16′, a reservoir 18′, a feed line 20′, an isolation valve 22′, a wheel brake 28′, a return line 32′, a pressure dissipation valve 34′, a pump 38′, an accumulator 42′, a pedal travel sensor 46′, a control unit 48′, an electric machine 50′ and a control unit 52. These components may be structurally identical and/or functionally identical to the corresponding components of the hydraulic brake system 10 of FIG. 1.

For example, the brake pedal 12′ may correspond and/or be structurally identical and/or functionally identical to the brake pedal 12, the brake force booster 14′ may correspond and/or be structurally identical and/or functionally identical to the brake force booster 14, the brake cylinder 16′ may correspond and/or be structurally identical and/or functionally identical to the brake cylinder 16, the reservoir 18′ may correspond and/or be structurally identical and/or functionally identical to the reservoir 18, the feed line 20′ may correspond and/or be structurally identical and/or functionally identical to the feed line 20, the isolation valve 22′ may correspond and/or be structurally identical and/or functionally identical to the isolation valve 22, the wheel brake 28′ may correspond and/or be structurally identical and/or functionally identical to the wheel brake 28, the return line 32′ may correspond and/or be structurally identical and/or functionally identical to the return line 32, the pressure dissipation valve 34′ may correspond and/or be structurally identical and/or functionally identical to the pressure dissipation valve 34, the pump 38′ may correspond and/or be structurally identical and/or functionally identical to the pump 38, the accumulator 42′ may correspond and/or be structurally identical and/or functionally identical to the accumulator 42, the pedal travel sensor 46′ may correspond and/or be structurally identical and/or functionally identical to the pedal travel sensor 46, the control unit 48′ may correspond and/or be structurally identical and/or functionally identical to the control unit 48, the electric machine 50′ may correspond and/or be structurally identical and/or functionally identical to the electric machine 50, and the control unit 52′ may correspond and/or be structurally identical and/or functionally identical to the control unit 52, of the hydraulic brake system 10 of FIG. 1. In this respect, reference is made to the description relating to the hydraulic brake system 10 of FIG. 1.

FIG. 2 illustrates four vehicle wheels, which are each assigned a wheel brake. The brake circuit under consideration comprises not only the wheel brake 28′ but also a further wheel brake 30, which is assigned to a different vehicle wheel. The two vehicle wheels with the associated wheel brakes 28′ and 30 may be present at a common axle or may be assigned to different axles, for example to the front axle and to the rear axle of a motor vehicle. FIG. 2 shows, by way of example, an assignment of the vehicle wheels to the front axle and to the rear axle in a diagonal configuration, wherein VR denotes the front right vehicle wheel, VL denotes the front left vehicle wheel, HR denotes the rear right vehicle wheel, and HL denotes the rear left vehicle wheel. By way of example, in FIG. 2, the electric machine 50′ is assigned to the rear axle. The electric machine 50′ interacts with the vehicle wheel at the rear left. For example, a further electric machine may be provided which interacts with the vehicle wheel at the rear right. It is also possible for the rear axle to be assigned an electric machine which is common to both vehicle wheels.

The two wheel brakes 28′ and 30 are jointly hydraulically connected to the feed line 20′, wherein, at one end, the brake cylinder 16′ is present and, at another end, the feed line 20′ divides into two line portions 20.1′ and 20.2′, which are in each case hydraulically connected to one of the wheel brakes 28′ and 30. The line portion 20.1′ is assigned the isolation valve 22′, and the line portion 20.2′ is assigned a separate isolation valve 24. The isolation valves 22′ and 24 are preferably structurally identical and/or functionally identical with respect to one another.

The return line 32 provided in the case of the hydraulic brake system 10 of FIG. 1 at least partially corresponds to the return line 32′, which is assigned the pump 38′ and the accumulator 42′. As viewed in the direction of the wheel brakes 28′ and 30, the return line 32′ divides into two line portions 32.1′ and 32.2′, which are in each case hydraulically connected to one of the wheel brakes 28′ and 30. Aside from the pressure dissipation valve 34′, a further pressure dissipation valve 36 is provided, which are assigned in each case to one of the line portions 32.1′, 32.2′ of the return line By means of the isolation valves 22′ and 24, each of the two wheel brakes 28′ and 30 can be separately hydraulically isolated. By means of the pressure dissipation valves 34′ and 36, it is possible, separately for each of the wheel brakes 28′ and 30, for a volume fraction of a hydraulic fluid displaced by means of the brake cylinder 16 to be conducted onward in the associated line portion 32.1′, 32.2′ of the return line 32′ in order to be stored in the accumulator 42′.

Preferably, the control unit 48′ is of extended functional scope in relation to the control unit 48 of the hydraulic brake system 10 in FIG. 1 such that, aside from the isolation valve 22′ and the pressure dissipation valve 34′, which are assigned to the wheel brake 28′, it is additionally also possible for the isolation valve 24 and the pressure dissipation valve 36, which are assigned to the wheel brake 30 to be activated. The isolation valve 24 and the pressure dissipation valve 36 are preferably activatable by the control unit 48 in the same way as the isolation valve 22′ and the pressure dissipation valve 34′ in order to perform the above-described regenerative braking process also with respect to the wheel brake 30. For example, the isolation valves 22′, 24 and the pressure dissipation valves 34′, 36 are a constituent part of an anti-lock braking system which is provided by means of the hydraulic brake system 10′. For example, the control unit 48′ is additionally configured for executing the hydraulic brake system 10′ during an anti-lock braking process.

As can be seen from FIG. 2, the feed line 20′ may be assigned a further isolation valve 26, which is arranged in the feed line between the division into the line portions 20.1′, 20.1′ and the brake cylinder 16. Furthermore, a supply valve 40 may be assigned to the return line 32′. By means of the supply valve 40, the return line 32′ can be hydraulically connected, bypassing the further isolation valve 26, to a region positioned upstream of the isolation valve 26. For example, the isolation valve 26 and the supply valve 40 are a constituent part of a driving dynamics control system (ESP). For example, the control unit 48′ is additionally configured for executing the hydraulic brake system 10′ during a driving dynamics control process.

In the present description, the reference to a particular aspect or a particular embodiment or a particular refinement means that a particular feature or a particular characteristic described in conjunction with the respective aspect or the respective embodiment or the respective refinement is comprised at least therein but need not necessarily be comprised in all aspects or embodiments or refinements of the present disclosure. It is expressly pointed out that any combination of the various features and/or structures and/or characteristics described with regard to the present disclosure are encompassed by the present disclosure unless this is expressly or positively ruled out by the context.

The use of individual or all examples or of an exemplary phrasing in the text is intended merely to illustrate the present disclosure and does not constitute a limitation with regard to the scope of the present disclosure, unless stated otherwise. Also, no phrasing or wording of the description is to be understood as referring to an element which is not claimed but which is essential for the practical implantation of the present disclosure.

What is claimed is:

1. A method for controlling a hydraulic brake system during a regenerative braking process, wherein a hydraulic fluid is displaced in the direction of a wheel brake by means of a brake cylinder, and wherein the method comprises the steps whereby at least a volume fraction of the hydraulic fluid is conducted via a pressure dissipation valve into an accumulator, an isolation valve is adjusted in the direction of a closed state in order to at least partially hydraulically isolate the wheel brake from the brake cylinder, and at least a volume fraction of the hydraulic fluid is conveyed out of the wheel brake by means of a pump.

2. The method as claimed in claim 1, wherein the hydraulic fluid is displaced from the brake cylinder in the direction of the wheel brake, the at least one volume fraction of the hydraulic fluid is simultaneously or subsequently conducted via the pressure dissipation valve into the accumulator, the isolation valve is adjusted in the direction of the closed state simultaneously with, or in a manner offset in terms of time in relation to, the conducting of the at least one volume fraction onward into the accumulator, and the at least one volume fraction of the hydraulic fluid is conveyed out of the wheel brake by means of the pump simultaneously with or subsequently to the adjustment of the isolation valve.

3. The method as claimed in claim 1, wherein the isolation valve is adjusted into the closed state in order to hydraulically fully isolate the wheel brake from the brake cylinder.

4. The method as claimed in claim 2, wherein the isolation valve is adjusted into the closed state in order to hydraulically fully isolate the wheel brake from the brake cylinder.

5. The method as claimed in claim 1, wherein such a volume fraction of the hydraulic fluid is conveyed out of the wheel brake by means of the pump that no braking force acts at the wheel brake.

6. The method as claimed in claim 4, wherein such a volume fraction of the hydraulic fluid is conveyed out of the wheel brake by means of the pump that no braking force acts at the wheel brake.

7. A hydraulic brake system for a motor vehicle, comprising:
a brake cylinder and a wheel brake which are hydraulically connected to one another via a feed line, wherein the brake cylinder is configured to displace a hydraulic fluid in the direction of the wheel brake, and the wheel brake is configured to exert a hydraulic braking force by means of the hydraulic fluid;
an isolation valve which is fluidically assigned to the feed line and which is configured to close the feed line;
a return line for returning at least a volume fraction of the hydraulic fluid from a region positioned downstream of the isolation valve into a region positioned upstream of the isolation valve;
a pressure dissipation valve, a pump and an accumulator, which are fluidically assigned to the return line, wherein the pump is configured to convey at least a volume fraction of the hydraulic fluid, the accumulator is configured to store at least a volume fraction of the hydraulic fluid, and the pressure dissipation valve is configured to open the return line;
a control unit which is connected in signal-exchanging fashion to the isolation valve, the pressure dissipation valve and the pump and which is configured such that, in the presence or upon an onset of an actuation of the brake cylinder and in particular in the presence or upon an onset of a generator braking force of an electric machine, the control unit activates the pressure dissipation valve for opening and activates the isolation valve for closing, in order to at least partially hydraulically isolate the wheel brake from the brake cylinder, and furthermore activates the pump to impart a conveying action, in order to lower a residual braking force which has a braking action on the wheel brake.

8. The brake system as claimed in claim 7, wherein the control unit is configured such that, in the presence or upon an onset of an actuation of the brake cylinder and in particular in the presence or upon an onset of a generator braking force of the electric machine, the control unit activates the pressure dissipation valve for opening, subsequently or simultaneously activates the isolation valve for closing, and, subsequently to or simultaneously with the activation of the isolation valve, activates the pump to impart a conveying action.

9. The brake system as claimed in claim 7, wherein the isolation valve and/or the pressure dissipation valve and/or the pump and/or the accumulator are a constituent part of an anti-lock braking system.

10. The brake system as claimed in claim 8, wherein the isolation valve and/or the pressure dissipation valve and/or the pump and/or the accumulator are a constituent part of an anti-lock braking system.
